(19) United States
(12) Patent Application Publication
(10) Pub. No.: US 2019/0145226 A1
(43) Pub. Date: May 16, 2019

(54) A METHOD AND DEVICE FOR OPTIMIZING A MODELLING OF FLOWS WITHIN A RESERVOIR FOR OPTIMIZATION OF OIL/GAS PRODUCTION

(71) Applicant: TOTAL SA, Courbevoie (FR)

(72) Inventors: Pierre BERGEY, Pau (FR); Nicolas EBERLE, Pau (FR)

(73) Assignee: TOTAL SA, Courbevoie (FR)

(21) Appl. No.: 16/308,752

(22) PCT Filed: Jun. 9, 2017
(86) PCT No.: PCT/EP2017/064195

§ 371 Date: Dec. 10, 2018

(30) Foreign Application Priority Data
Jun. 10, 2016 (EP) 16305686.4

(51) Int. Cl. E21B 41/00; G06F 17/50; G01V 99/00

(52) U.S. Cl. CPC E21B 41/0092; E21B 47/06; G01V 99/005; G06F 17/5009

(57) ABSTRACT

The present invention relates to a method for optimizing a modeling of flows within a reservoir for optimization of oil/gas production, by receiving a first time step; receiving a flow condition for at least one well connected to the reservoir, selecting data in the control data that is applicable to the first time step; then determining at least one quality value based on the selected data. If a quality criterion is not met based on the quality value, determining a second time step within the first time step and reiterating step /c/ to /e/ with the second time step as the first time step. If the quality criterion is met based on the quality value, performing a modeling of flows within the reservoir based on said first time step.

### RELATED APPLICATIONS

The present application is a National Phase entry of PCT Application No. PCT/EP2017/064195, filed Jun. 9, 2017, which claims priority from EP Patent Application No. 16305686.4, filed Jun. 10, 2016, said applications being hereby incorporated by reference herein in their entirety.

### FIELD OF THE INVENTION

The present invention relates to simulation optimization especially for modeling a multiphase flow within an oil/gas reservoir (porous medium) and from wells positioned within such reservoir.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

The flow modeling algorithms are often used to predict fluid flows at wells and within a reservoir and/or to improve knowledge of model input through an inversion process.

The input of a reservoir flow simulator consists in:
A “static” reservoir model (M or element 101 of FIG. 1). Such reservoir model is typically comprised of a cellular grid, associated cell properties and model scale properties.
One or two time-dependent simulation controls corresponding respectively to the history and forecast periods. Time dependent controls are provided relative to time intervals between control dates. Such time intervals are often labeled as “control steps” (Qₜ^{i p} or element 102 of FIG. 1, where i being the number of the control (or well number), t being the time, p being the phase number of the fluid (e.g. the oil, the water, the gas, etc.)): a set of control steps be named as “control data”.

The basic output of a reservoir flow simulator consists in a series of time-dependent reservoir and well(s) flow states (element 106 of FIG. 1).

In order to be able to provide such output, the simulator often has a stepping module (element 103 of FIG. 1) and a core simulation module (element 104 of FIG. 1).

The time stepping module is designed to determine the accurate “time steps” for an iterative simulation performed by the core simulation module.

A time step is limited by two simulations dates. Time steps are distinct from control steps.

For each “time step” within a period to be simulated, the core simulation module provides a flow modeling of the reservoir that may satisfy well and reservoir controls (such as the flow at wells, pressure, temperature, etc.) or at least a mean of such well and reservoir controls during the considered time step: the flow modeling being a forecast/reconstruction of well and flow states applicable to the considered time step. When the core simulation module has provided the flow modeling for one given step (test 105 of FIG. 1), the process is reiterated (i.e. redetermination of the next time step and core simulation of said new step) until the end of the period to be simulated.

The determination of the accurate time step is a key component of the global simulation.

Most of the time, the time steps are determined based on time-dependent heuristic, e.g.:
the time steps are determined to fulfil a maximum duration criterion, such as “the simulation should last no more than 48 hours”. If the maximum duration criterion is not fulfilled (e.g. the simulation is expected to last more than 48 hours), the time steps are increased so that the number of steps is limited.
the time steps are also determined to fulfil a minimum duration criterion, such as “the simulation should last at least 24 hours”. If the minimum duration criterion is not fulfilled (e.g. the simulation is expected to last 12 hours), the time steps are decreased so that the number of steps is increased.

Nevertheless, these methods of time stepping are only driven by duration/time consideration.

Another time stepping method may be an a priori setting by the user: for instance, the user may indicate to the simulation algorithm that N steps should be performed (with N, an integer).

This latter method is only driven by a subjective approach. Therefore, the simulation process can certainly be very poor if the user set the number of steps incorrectly.

Another method (i.e. “flexible stepping logic”) determines the time step of a given period based on a convergence function of the simulation for the previous determined time step: therefore, if the simulation for the previous determined time step was very complex (i.e. the time for convergence of the simulation was quite long), the new time step may be determined according to the previous determined time step. Therefore, due to convergence issue, this time stepping method may choose quite a long time step, regardless the accuracy/quality of the simulation.

There is thus a need to provide a time stepping to take into account a quality criterion for the simulation. Indeed, improving the simulation (e.g. the simulated pressure frequency content) is of particular importance for inverting the static model based upon a comparison between simulated and observed flows in well or reservoir observations (history matching) and for representing transient effects in well and flow lines.

### SUMMARY OF THE INVENTION

The invention relates to a method for optimizing a modeling of flows within a reservoir for optimization of oil/gas production, said modeling comprising a determination of a time step within a simulation period, the method comprising:
/a/ receiving a first time step;
/b/ receiving control data applicable to said simulation period and comprising flow condition for at least one well connected to the reservoir;
/c/ selecting data corresponding to the control data and that is applicable to the first time step;
/d/ determining at least one quality value based on the selected data;
/e/ if a quality criterion is not met based on the quality value, determining a second time step within the first time step and reiterating step /c/ to /e/ with the second time step as the first time step;
/f/ if the quality criterion is met based on the quality value, performing a modeling of flows within the reservoir based on said first time step.

A flow condition is a time-dependent set of data indicating the flow of the well during a period of time: the flow condition may comprise flows (per phase and or global flows), pressure, and/or temperature and may be specific for a well/part of a well.

The control data may be derived from real historical data of the well (e.g. the real flow of the well during a former period).

The first time step may be determined by another method or predetermined by a user.

The at least one quality value is then function of the control data and is not exclusively function of the simulation complexity.

The second time step within the first time step has time boundaries inside the boundaries of the first time step. Most of the time, at least one boundary of the second time step is identical to a boundary of the first time step while the other boundary of the second time step is strictly lower than the other boundary of the first time step.

Thanks to said method, it is possible to enhance the simulation and limit the size of the time step even if convergence of the simulation is very quick. As the simulation could converge to the mean of the control data for said first time step, it is important to assess the quality of the data to be sure that the core simulation is about to converge to a value with high quality (i.e. close to the real control data).

As the simulation of flows is more accurate and takes into account the quality of the control data, it is possible to adapt/optimize the oil/gas production of well(s) connected to the reservoir. Knowing in a accurate manner the flow into the reservoir, it is also possible to determine the best possible position of new well(s) to be drilled. Therefore the oil and gas production of real oil/gas reservoir/field may be optimized.

In one possible embodiment, the determination of the quality value may comprise a determination of a root mean square error of the selected data.

Therefore, such method enables the determination of a highly variable set of control data that is not adequate for a core simulation.

In addition, the determination of the quality value may comprise a determination of a mean absolute error of the selected data.

Furthermore, the determination of the quality value may comprise a determination of a mean frequency of a frequency transform of the selected data.

This method provides a proper and efficient way to assess the variability of the control data during the first time step. In addition, said method may be physically implemented thanks to dedicated hardware.

For instance, the quality criterion may be not met if the quality value is greater than a predetermined value.

The method may further comprise:
/b2/ receiving pressure and temperature values for a bottom hole of said at least one well connected to the reservoir;
/b3/ converting the selected data based on said received pressure and temperature values.

The converted data may be used for the determination of step /d/.

By converting the control data or the selected data to the bottom hole of the well, the control data may be more relevant for the core simulation, as the core simulation manipulates data directly in the reservoir conditions, close to the bottom hole conditions of the well: as the error/quality may be expressed in the bottom hole condition, the accuracy may be better represented in the bottom hole conditions close to the reservoir conditions.

In a possible embodiment, the determination of the quality value may comprise a binarization of at least the selected data.

The binarization eases the automatic identification of the closure/opening of the well and therefore eases the positioning of the boundaries of the time step close to said closure/opening. By doing so, the error of the core simulation for said transitional period (i.e. closure/opening) may be significantly reduced.

Advantageously, the simulation period may be determined to exclude periods of time in which the at least one well ceases to have non-null flow condition or ceases to have a null flow condition.

In one example, the simulation period may be split into a plurality of simulation periods to exclude periods of time in which the at least one well ceases to have non-null flow condition or ceases to have a null flow condition.

These periods of time (i.e. periods of time in which the at least one well ceases to have non-null flow condition or ceases to have a null flow condition) may be identified as closure/opening of the well and/or as transitional period for the production of the well.

The determination of the quality value may comprise a determination of a respective quality sub-value for each of the wells, the quality value being determined based on a weighted sum of the respective quality sub-values.

Hence, respective weights of the weighted sum may be a function of a flow of each well during the first time step or the simulation period.

A second aspect of the invention relates to a device for optimizing a modeling of flows within a reservoir for optimization of oil/gas production, said modeling comprising a determination of a time step within a simulation period, the device comprising:
/a/ an interface for receiving a first time step;
/b/ an interface for receiving control data applicable to said simulation period and comprising flow condition for at least one well connected to the reservoir;
/c/ a first circuit for executing an action of selecting data corresponding to the control data and that is applicable to the first time step;
/d/ a second circuit for executing an action of determining at least one quality value based on the selected data;
/e/ a third circuit for, if a quality criterion is not met based on the quality value, executing an action of determining a second time step within the first time step and for controlling the first circuit, the second circuit, the third circuit to execute their actions with the second time step as the first time step.
/f/ a fourth circuit for, if the quality criterion is met based on the quality value, performing a modeling of flows within the reservoir based on said first time step.

A third aspect relates to a computer program product comprising a computer-readable medium, having thereon a computer program comprising program instructions. The computer program is loadable into a data-processing unit and adapted to cause the data-processing unit to carry out the method described above when the computer program is run by the data-processing unit.

Other features and advantages of the method and apparatus disclosed herein will become apparent from the following description of non-limiting embodiments, with reference to the appended drawings.

### BRIEF DESCRIPTION OF THE DRAWINGS

The present invention is illustrated by way of example, and not by way of limitations, in the figures of the accompanying drawings, in which like reference numerals refer to similar elements and in which:

FIG. 1 is an overview of a global simulation process that can be enabled by the invention.

FIG. 2a is a graph illustrating a first method of determination of a time step based on one possible embodiment of the invention;

FIG. 2b is a graph illustrating a second method of determination of a time step based on one possible embodiment of the invention;

FIG. 2c is a graph illustrating a third method of determination of a time step based on one possible embodiment of the invention;

FIG. 2d is a graph illustrating a fourth method of determination of a time step based on one possible embodiment of the invention;

FIG. 3a is a flow chart describing a possible embodiment of the first method of the present invention;

FIG. 3b is a flow chart describing a possible embodiment of the second method of the present invention;

FIG. 3c is a flow chart describing a possible embodiment of the third method of the present invention;

FIG. 3d is a flow chart describing a possible embodiment of the fourth method of the present invention;

FIG. 3e is an example of weighting quality values for a plurality of wells;

FIG. 4 is a possible embodiment for a device that enables the present invention.

### DETAILED DESCRIPTION OF THE DRAWINGS

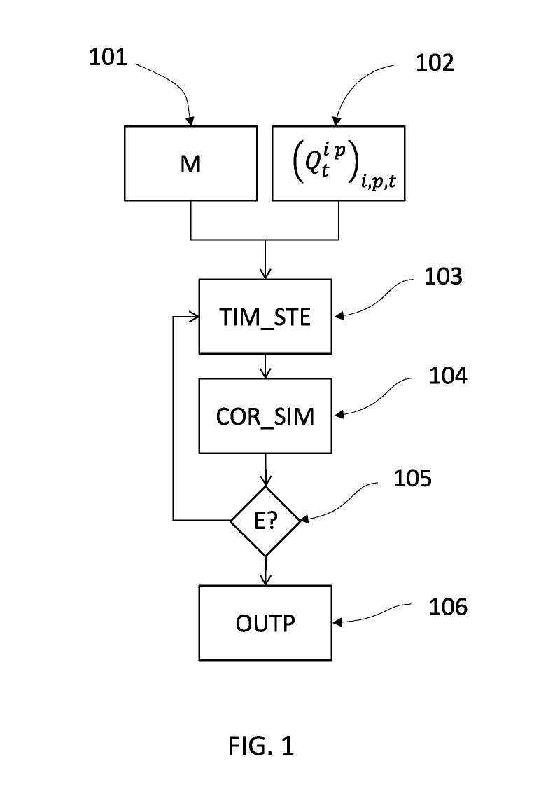

FIG. 1 is an overview of a global simulation process that can be enabled by the invention.

As described above, the simulation process comprises two main modules that iterate on a plurality of consecutive periods of time (i.e. time steps). The time step module 103 is in charge of determining the accurate time step that will be an input of the core module 104.

According to the description below, it is advantageous to enhance the time step module for increasing the accuracy of the time step module and to take into account a quality of the received control data (Qₜ^{i p})_{i,p,t} for the determination by the core simulation module.

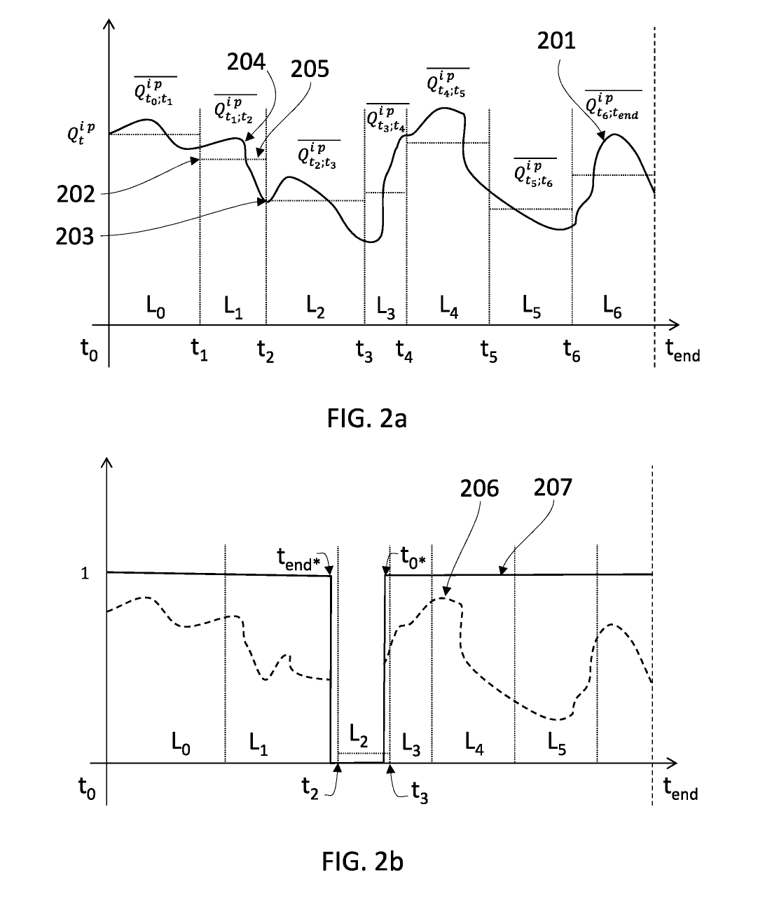

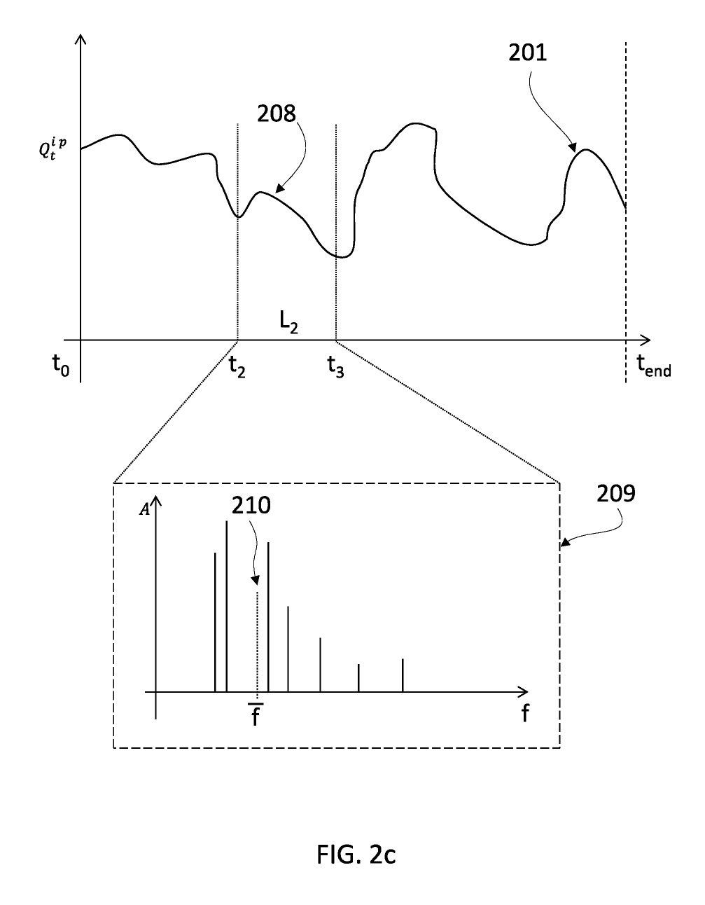

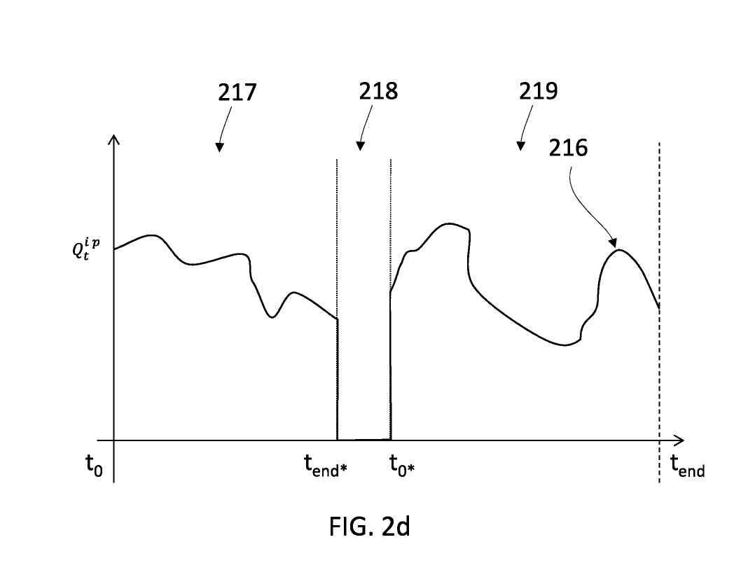

FIG. 2a is a graph illustrating a first method of determination of a time step based on one possible embodiment of the invention.

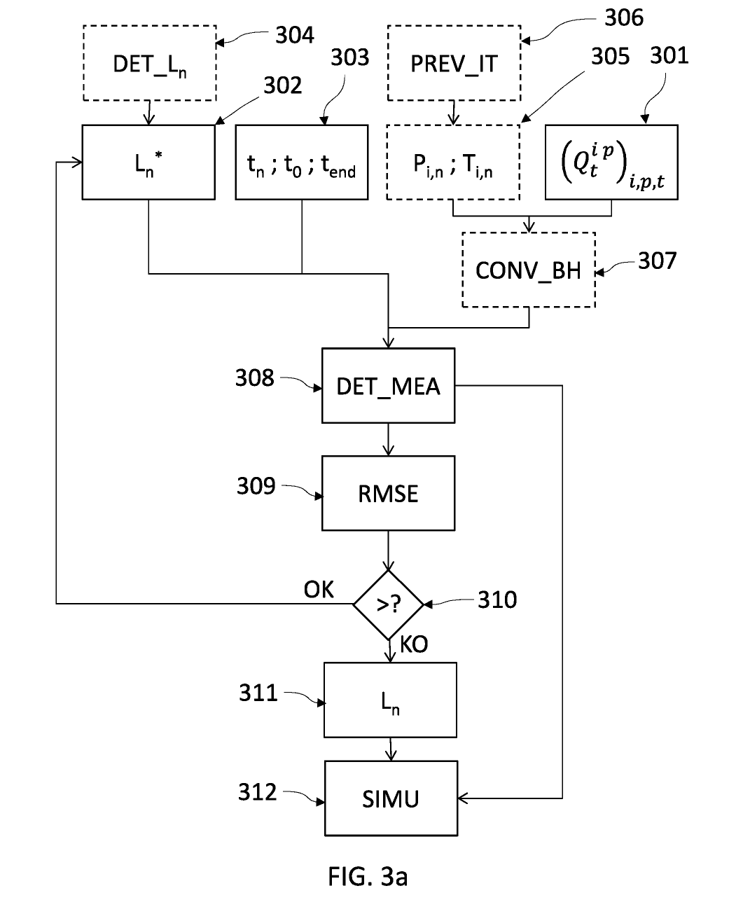

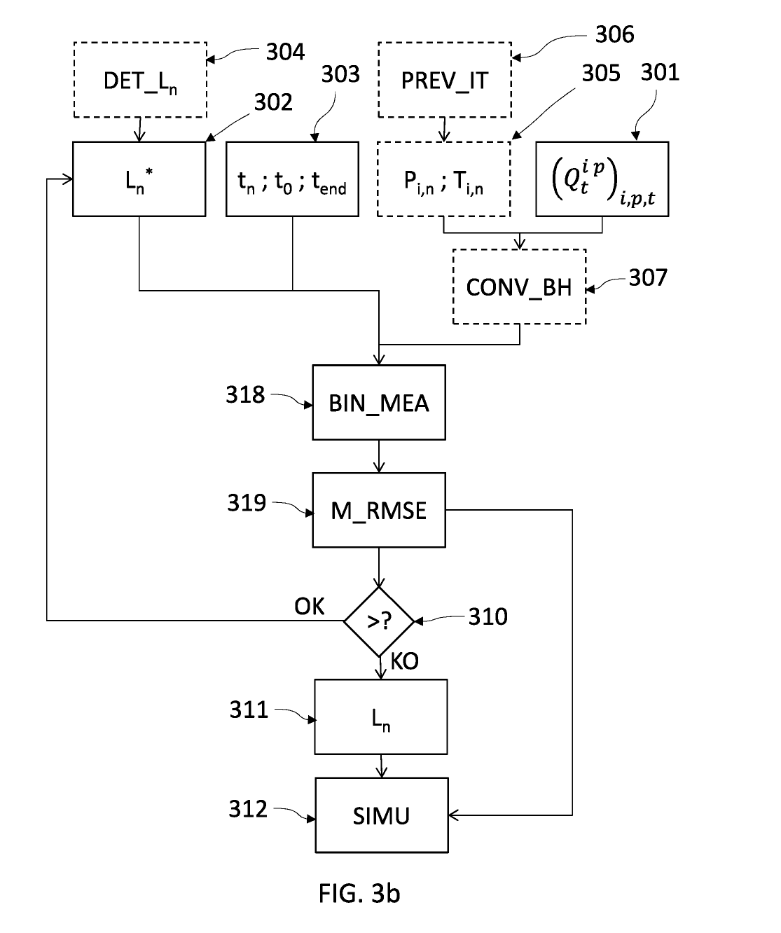

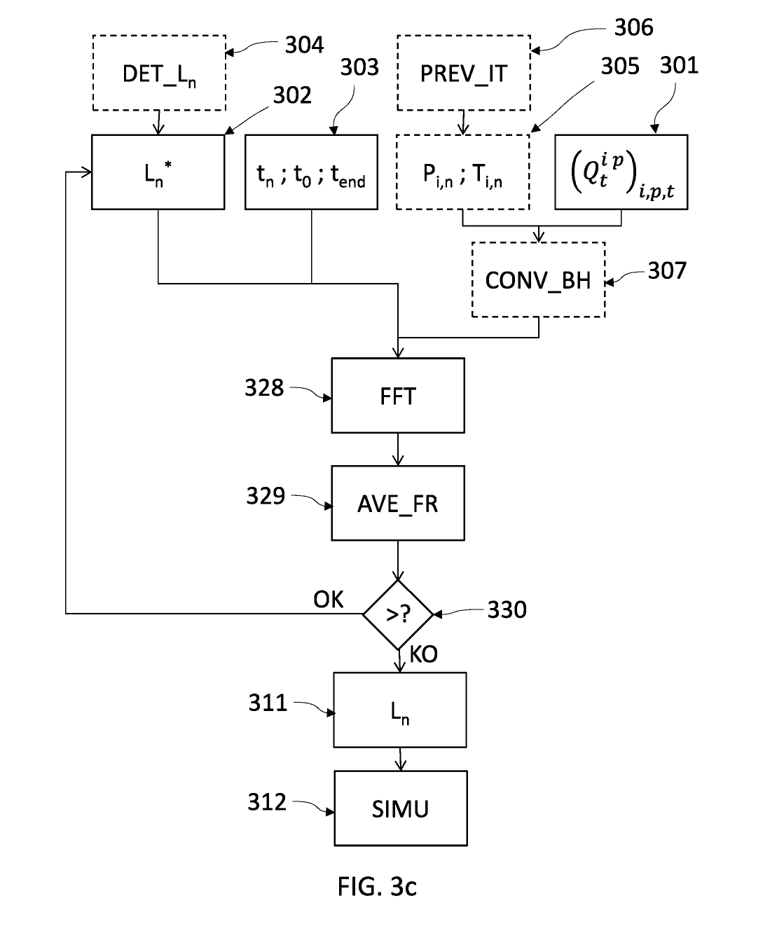

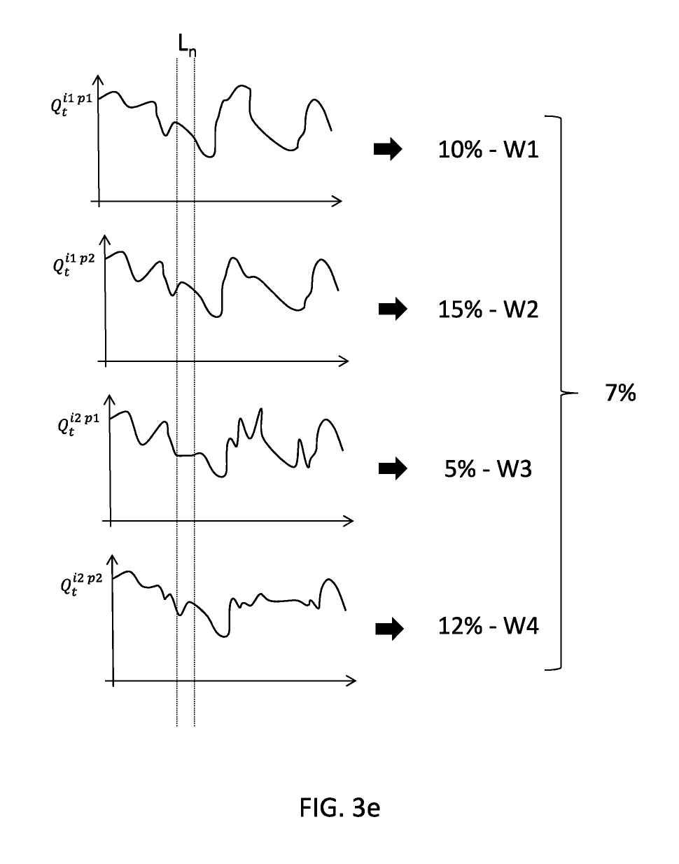

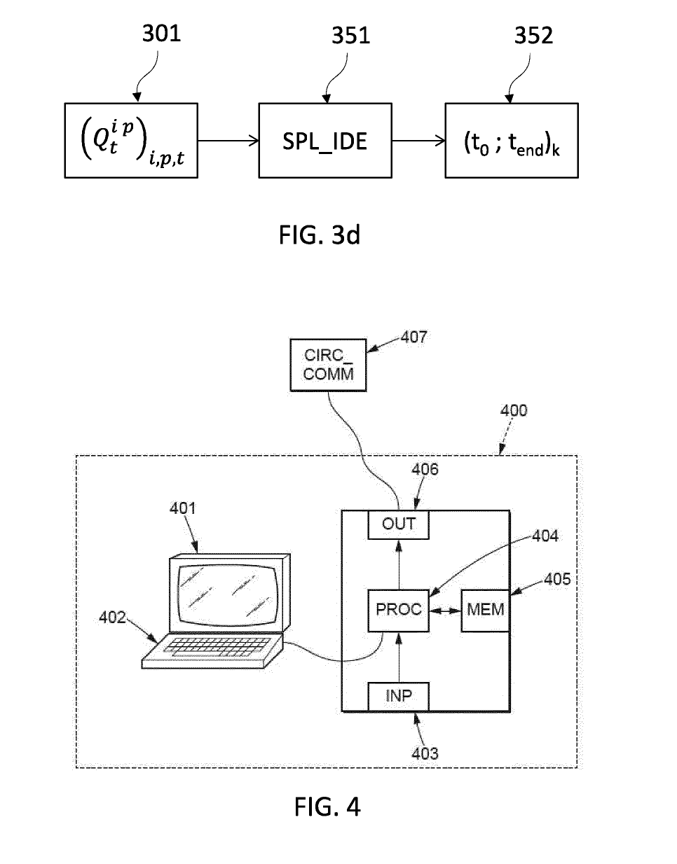

In this method, it is possible to receive the control data (Qₜ^{i p})_{i,p,t} (step 301 of FIG. 3a). This control data (for instance, the flow for a well p and for a phase i, given for a plurality of time t) may be represented as a time graph 201 (only one graph is represented in FIG. 2a, for a given p and i).

In addition, it is possible to receive a provisional time step Lₙ* (step 302 of FIG. 3a) and a set of time tₙ, t₀ and t_{end} (step 303 of FIG. 3a).

The provisional time step Lₙ* can be set by the user for each iteration of step 103-104-105 as described above or can be set by an additional determination module such as implementing one of the time stepping method (step 304 of Figure FIG. 3a) described above such as the “flexible stepping logic” or such as another method described in the present application. The present method corrects the provisional time step Lₙ* to provide an accurate time step Lₙ.

The time tₙ defines the start of the simulation time step.

The time t₀ defines the start of the simulation period (that includes the time steps).

The time t_{end} defines the end of the simulation period (that includes the time steps).

In one embodiment, it is also possible to optionally receive pressure information P_{i,n} at the bottom hole of well i and temperature information T_{i,n} (step 305 of FIG. 3a). This information may be set by the user (e.g. predetermined temperature and pressure) or may be derived from the previous iteration if any (step 306 of FIG. 3a). As the control data Qₜ^{i p} are often provided at the surface of the well i, it may be advantageous to convert said control data to the bottom hole with standard techniques using the pressure and temperature at the bottom hole of the given well i (step 307 of FIG. 3a). If such conversion occurs, the “control data” should be understood in the following (unless otherwise mentioned) as the “converted control data” and the same notation Qₜ^{i p} is used for both. By converting the control data to the bottom hole, it is possible to have more accurate data to control the simulation of the core module/time stepping module: therefore the accuracy of the time steps could be better.

For the given provisional time step Lₙ*, it is first possible to determine if said provisional time step Lₙ* ends before the finale time t_{end}, for instance by computing:

Lₙ*=min(Lₙ*+tₙ;t_{end})−tₙ

Then, for each well i and phase p, it is possible to determine the mean of the control data Qₜ^{i p} that is applicable to the provisional time step Lₙ* (step 308 of FIG. 3a).

It should be understood that “the control data Qₜ^{i p} that is applicable to the provisional time step Lₙ*” means the data of the control data Qₜ^{i p} that have a time t that corresponds to the provisional time step Lₙ* (i.e. t being within the time limit of Lₙ*). For instance, if the time step L₁ in FIG. 2a have two time limits t₁ and t₂, it is possible to select the data of the control data Qₜ^{i p} (element 201 of FIG. 2a) that is applicable to L₁ by selecting the data 204 which are in the interval defined by the dashed lines 202 and 203 starting from t₁ and t₂. Once the data 204 selected, a mean Q̅ₜ̅_̅{̅₁̅}̅_̅{̅;̅t̅}̅_̅{̅₂̅}̅^̅{̅i̅ p̅}̅ 205 may be easily determined.

Once the mean determined, it is possible to determine a quality value (step 309 of FIG. 2a) of the control data Qₜ^{i p} compared to said mean. For instance, it is possible to compute as a quality value:
a root mean square error of the control data Qₜ^{i p} (i.e.

$$\frac{[ \sqrt{{\sum }_{k} {( {Q}_{{t}_{k}}^{i p} - \overline{{Q}_{{t}_{1} ; {t}_{2}}^{ι p}} )}^{2}} ]}{k} ,$$

with k the index of the control data within the time step Lₙ*)
a mean absolute error of the control data Qₜ^{i p} (i.e.

$$\frac{[ {\sum }_{k} \vert {Q}_{{t}_{k}}^{i p} - \overline{{Q}_{{t}_{1} ; {t}_{2}}^{ι p}} \vert ]}{k} ,$$

with k the index of the control data within the time step Lₙ*)
the surface between the control data curve 204 and the mean 205 divided by the length of the time step Lₙ*.

The quality value is based on the control data itself and is not exclusively derived from time/duration consideration (of the simulation).

Therefore the quality value is intrinsically linked to the control data.

In the previous examples:
if the quality value is high, it means that the control data is not close to its mean, i.e. the control data varies a lot in the time step Lₙ*;
if the quality value is low (i.e. close to zero), it means that the control data is close to its mean, i.e. the control data does not vary a lot in the time step Lₙ*.

Here, the computed quality value is decreasing with the quality of the data. The best the data is, the lower the quality value is.

As a consequence, the determination heuristic may be:
if the quality value is greater than a predetermined value (step 310 of FIG. 3a, output OK), the provisional time step Lₙ* is shorten and the process described in step 308 and 309 of FIG. 3a is reiterated.
if the quality value is lower than the predetermined value (step 310 of FIG. 3a, output KO), the provisional time step Lₙ* is taken as the time step Lₙ (step 311 of FIG. 3a) for the simulation by the core module (step 312 of FIG. 3a). In addition, the last computed mean of step 308 may be input to the core module as the simulation may try to satisfy said mean as control data for the time step Lₙ.

It is also possible that a computed quality value is increasing with the quality of the data (for instance, by computing the inverse of the previous quality data). Therefore, determination heuristics may be adapted by replacing “greater” by “lower” and vis-et-versa.

The same process may be reiterated with the time steps L₀, L₂, L₃, L₄, L₅, L₆. As the start of the time steps may be a function of the previous time steps, it may be advantageous to iterate the process according to the time order of the time step.

It is noted that the quality value may be a dimensionless number, a number or a percentage or any other metrics.

FIG. 2b is a graph illustrating a second method of determination of a time step based on one possible embodiment of the invention.

In FIG. 2b, the process used is very close to the process that is used for FIG. 2a: therefore, the flowchart of FIG. 3b is identical to the flowchart of FIG. 3a (and its associated description applies) as long as the numerical references are identical.

In this example, the production of the well i may be stopped between time t_{end}* and t₀*, i.e. the flow condition of the well i is equal to 0 for a period of time [t_{end}*−t₀*]: the well i ceases to have non-null flow condition at time t_{end}* and ceases to have a null flow condition at time t₀* (see curve 206).

When such situation may occur, it may be advantageous to binarize (step 318 of FIG. 3a) the control data Qₜ^{i p} (curve 206) (i.e. to transform part of the curve into 0-1 signal—or at least into a signal having two possible values) into a new signal 207: a first value (e.g. 0) if the condition data is null/the well is closed—a second value (e.g. 1) if the condition data is non-null/the well is in operation.

Once this binarization performed, it is possible to determine (step 319 of FIG. 3a) the quality value of the binarized signal 207 the same way the quality value has been determined for curve 201 in FIG. 2a (i.e. by executing step 308 and 309 on the binarized signal).

For most of the time steps, the binarized signal is constant during the considered time step and therefore no modification of the provisional time step Lₙ* is requested. For time steps overlapping (at least) one change in the binarized signal (i.e. L₁ overlaps t_{end}*, and L₂ overlaps t₀* in the example of FIG. 2b), the process described in FIG. 3b leads to modify the boundaries of said time steps to a position in time very close to these changes (e.g. t₂ is close to t_{end}*, t₃ is close to t₀*).

If the predetermined value is 0, the boundaries of said time steps are the positions in time of these changes.

As a consequence, it is possible to automatically create time steps closely aligned with the changes in production of the wells: the transitional period can be accurately simulated by the core module based on this time stepping method.

FIG. 2c is a graph illustrating a third method of determination of a time step based on one possible embodiment of the invention.

In FIG. 2c, the process used is very close to the process that is used for FIG. 2a: therefore, the flowchart of FIG. 3c is identical to the flowchart of FIG. 3a (and its associated description applies) as long as the numerical references are identical.

In this example, a frequency based method is presented to adapt the length of the provisional time step Lₙ*.

In particular, the step 308 is replaced by step 328, step 309 is replaced by step 329 and test 310 is replaced by step 330.

In step 328, the data 208 of the data of the control data Qₜ^{i p} that is applicable to the provisional time step Lₙ* (in the present case of FIG. 2c, L₂) is selected and a time frequency transform is computed on said selected data. The transform may be illustrated in element 209 of FIG. 2c.

Once said transform computed, it is possible to compute the average frequency 210 in this transform (step 329 of FIG. 3c).

This average frequency 210 may act as the quality value described above.

As a consequence, the determination heuristic may be:
if the average frequency 210 is greater than a predetermined value (step 330 of FIG. 3c, output OK), the provisional time step Lₙ* is shorten and the process described in steps 328 and 329 of FIG. 3c are reiterated.
if the average frequency 210 is lower than the predetermined value (step 330 of FIG. 3c, output KO), the provisional time step Lₙ* is taken as the time step Lₙ (step 311 of FIG. 3c) for the simulation by the core module (step 312 of FIG. 3a). In addition, a mean of the control data applicable to time step Lₙ may be computed to be to the core module.

FIG. 2d is a graph illustrating a fourth method of determination of a time step based on one possible embodiment of the invention.

In this example, the production of the well i may be stopped between time t_{end}* and t₀*, i.e. the flow condition 216 of the well i is equal to 0 for a period of time [t_{end}*−t₀*]: t_{end}* and t₀* may be defined as “operational transitions”.

When such situation may occur, it may be advantageous to divide (step 351 in FIG. 3d) the simulation period t₀-t_{end} into sub-periods that do not have any “operational transition” in any well i. For instance, for the well i, the simulation period may be split into three sub-periods 217, 218, 219. If more than one well exists for the considered reservoir connected to the wells, the sub-periods should be adapted to satisfy said condition (no “operational transition”) for every well.

The above described process(es) may then be run for every determined sub-period as the simulation period (step 352).

FIGS. 3a-3d are flow charts describing possible embodiments of the present invention as described above. Part(s) of these flow charts can represent steps of an example of a computer program which may be executed by the device of FIG. 4.

It is noted that method of FIGS. 3a-3c may be executed individually, alternatively, consecutively (each outputted Lₙ is used for Lₙ* in another method) or in parallel (the shorten outputted Lₙ is used).

FIG. 3e is an example of weighting quality values for a plurality of wells.

In the previous figures, a quality value is determined for a single well and for a single phase. If the considered reservoir has a plurality of wells connected to and/or a plurality of phases in the production flow (i.e. the index i of the control data Qₜ^{i p} may be greater than 1 and/or the index p of the control data Qₜ^{i p} may be greater than 1), it is possible to compute a “global quality value” for every well and for every phase taking into account every quality value of each well and each phase.

Therefore, the example of FIG. 3e is only a small adaptation of steps 308-309, 318-319 and 328-329.

First, it is possible to determine the quality value for each well and each phase as described above for the time step Lₙ.

For instance:
for well i1 and phase p1, having control data Qₜ^{i1 p1}, the computed quality value is 10%;
for well i1 and phase p2, having control data Qₜ^{i1 p2}, the computed quality value is 15%;
for well i2 and phase p1, having control data Qₜ^{i2 p1}, the computed quality value is 5%;
for well i2 and phase p2, having control data Qₜ^{i2 p2}, the computed quality value is 12%.

Once the quality value is determined for each well and each phase, it is possible to compute a global quality value as a weighted sum of the quality values (or quality sub-values) of each well and each phase.

For instance, by applying a weight of W1 for well i1 and phase p1, a weight of W2 for well i1 and phase p2, a weight of W3 for well i2 and phase p1, a weight of W4 for well i2 and phase p2, it is possible to determine that the global quality value is 7%:

$$\frac{10 \% W 1 + 15 \% W 2 + 5 \% W 3 + 13 \% W 4}{W 1 + W 2 + W 3 + W 4}$$

The weight may be a function of:
the flow of the well i and of the phase p (e.g. the higher the flow is, the greater the weight is). This “flow” may be the mean of the flow during the whole simulation period or during the provisional time step Lₙ* or during any other time period;
the strategic value of the well (e.g. the more important the well is regarding an economic value, the greater the weight is). This strategic value may be user-determined;
etc.

FIG. 4 is a possible embodiment for a device that enables the present invention.

In this embodiment, the device 400 comprise a computer, this computer comprising a memory 405 to store program instructions loadable into a circuit and adapted to cause circuit 404 to carry out the steps of the present invention when the program instructions are run by the circuit 404.

The memory 405 may also store data and useful information for carrying the steps of the present invention as described above.

The circuit 404 may be for instance:
a processor or a processing unit adapted to interpret instructions in a computer language, the processor or the processing unit may comprise, may be associated with or be attached to a memory comprising the instructions, or
the association of a processor/processing unit and a memory, the processor or the processing unit adapted to interpret instructions in a computer language, the memory comprising said instructions, or
an electronic card wherein the steps of the invention are described within silicon, or
a programmable electronic chip such as a FPGA chip (for «Field-Programmable Gate Array»).

This computer comprises an input interface 403 for the reception of data used for the above method according to the invention and an output interface 406 for providing the simulated model/flows to an external module 407.

To ease the interaction with the computer, a screen 401 and a keyboard 402 may be provided and connected to the computer circuit 404.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the invention.

1. A method for optimizing a modeling of flows within a reservoir for optimization of oil/gas production, said modeling comprising a determination of a time step within a simulation period, the method comprising:
/a/ receiving a first time step;
/b/ receiving a control data applicable to said simulation period and comprising a flow condition for at least one well connected to the reservoir,
/c/ selecting data corresponding to the control data and that is applicable to the first time step;
/d/ determining at least one quality value based on the selected data;
/e/ if a quality criterion is not met based on the quality value, determining a second time step within the first time step and reiterating steps /c/ to /e/ with the second time step as the first time step; and
/f/ if the quality criterion is met based on the quality value, performing a modeling of flows within the reservoir based on said first time step.

2. The method according to claim 1, wherein the determination of the quality value comprises a determination of a root mean square error of the selected data.

3. The method according to claim 1, wherein the determination of the quality value comprises a determination of a mean absolute error of the selected data.

4. The method according to claim 1, wherein the determination of the quality value comprises a determination of a mean frequency of a frequency transform of the selected data.

5. The method according to claim 1, wherein the quality criterion is not met if the quality value is greater than a predetermined value.

6. The method according to claim 1, wherein the method further comprises:
/b2/ receiving a pressure and a temperature value for a bottom hole of said at least one well connected to the reservoir;
/b3/ converting the selected data based on said received pressure and temperature values;
wherein the converted data is used for the determination of step /d/.

7. The method according to one claim 1, wherein the determination of the quality value comprises a binarization of at least the selected data.

8. The method according to one claim 1, wherein the simulation period is determined to exclude periods of time in which the at least one well ceases to have a non-null flow condition or ceases to have a null flow condition.

9. The method according to claim 1, wherein the simulation period is split into a plurality of simulation periods to exclude periods of time in which the at least one well ceases to have a non-null flow condition or ceases to have a null flow condition.

10. The method according to claim 1, wherein the determination of the quality value comprises a determination of a respective quality sub-value for each of the wells, the quality value being determined based on a weighted sum of the respective quality sub-values.

11. The method according to claim 10, wherein respective weights of the weighted sum are functions of a flow of each well during the first time step or the simulation period.

12. A non-transitory computer readable storage medium, having stored thereon a computer program comprising program instructions, the computer program being loadable into a data-processing unit and adapted to cause the data-processing unit to carry out the steps of claim 1 when the computer program is run by the data-processing device.

13. A device for optimizing a modeling of flows within a reservoir for optimization of oil/gas production, said modeling comprising a determination of a time step within a simulation period,
the device comprising:
/a/ an interface for receiving a first time step;
/b/ an interface for receiving a control data applicable to said simulation period and comprising a flow condition for at least one well connected to the reservoir;
/c/ a first circuit for executing an action of selecting data corresponding to the control data and that is applicable to the first time step;
/d/ a second circuit for executing an action of determining at least one quality value based on the selected data;
/e/ a third circuit for, if a quality criterion is not met based on the quality value, executing an action of determining a second time step within the first time step and for controlling the first circuit, the second circuit, the third circuit to execute their actions with the second time step as the first time step, and
/f/ a fourth circuit for, if the quality criterion is met based on the quality value, performing a modeling of flows within the reservoir based on said first time step.
